(19) United States
(12) Patent Application Publication
(10) Pub. No.: US 2019/0267780 A1
(43) Pub. Date: Aug. 29, 2019

(54) Powered cable splitter

(71) Applicant: Trevor Smith, Broomfield, CO (US)

(72) Inventor: Trevor Smith, Broomfield, CO (US)

(21) Appl. No.: 15/854,625

(22) Filed: Dec. 26, 2017

(51) Int. Cl. H02G 1/12; H02G 1/00; B25B 5/00

(52) U.S. Cl. CPC H02G 1/1217; B25B 5/00; H02G 1/1236; H02G 1/005

(57) ABSTRACT

The invention is directed to a powered cable splitter. The splitter is comprised of a motor, a blade, a channel, a clamp to secure the tubing within the channel, and a hand grip for activating the motor. To use the splitter, a user places the cable inside of the channel, secures it with the clamp, and then squeezes the hand grip to activate the motor. The motor causes the blade to spin and cut to a specific depth. Rollers within the channel allow the cable to be moved into position before the tubing is cut, creating a cut of limited depth along a preferred length, and thus splitting the cable without damaging the wires within.

### CROSS-REFERENCE TO RELATED APPLICATIONS

This application relates back to, and claims the priority of Provisional Patent Application No. 62/431,902 filed on Dec. 26, 2016.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to power tools and in particular to a powered cable splitter. At most construction and renovation work sites, splitting electric cable such as MX cable has become necessary. Unfortunately, the current use of hand tools to split the cable presents a problem when cutting and splitting the cable, costing time and money. It is extremely difficult to longitudinally split or cut off the insulation material without damaging the cable.

A search of the prior art reveals various devices which have been developed to provide a longitudinal cut or split on a length of cable. None are closely related to the present invention, but several include features which resemble those of the present invention. Each has proven to be less than satisfactory for the present purpose in its own way.

Insulation-removing pliers, U.S. Pat. No. 3,902,206 (priority Sep. 20, 1973), provides a hand tool primarily for use with electrical wiring which combines into one tool all the necessary tools normally required when removing insulation from an electrical wire. The tool includes upper and lower jaws, both of which contain several cutting elements, and an insulation-gripping element, the bottom jaw having a knife or splitter connected thereto for splitting electrical insulation.

Splitter for electric cable, U.S. Pat. No. 4,536,957 (priority Apr. 14, 1982), provides a cable splitter for splitting the outside sheath of a cable containing one or more inner conductors. The cable splitter comprises an elongated member having a trough disposed along the entire longitudinal length thereof. A handle is connected to the distal end of the elongated member. A cutting element is positioned through a boss connected to the proximal end of the elongated member such that the cutting edge of the cutting element extends into the trough. The amount by which the cutting edge extends into the trough is made adjustable by means of set screws threadably disposed through the boss to engage the cutting element. Preferably the trough comprises a cross-sectional configuration substantially identical to the cross-sectional configuration of the cable to be slit. This enables the cable splitter of this invention to slit the sheath of the cable along the edge thereof, rather than along the flat, mid-portion of the cable. In an alternative embodiment, a first elongated member has a first trough located along the longitudinal length thereof. A second elongated member has a second trough located along the longitudinal length thereof and a beading strip which cooperates with the first trough to lock the first and second elongated members together. A transverse channel extends through the first and second elongated members and the beading strip to guide an adjustably located cutting element such that the cutting edge of the cutting element is disposed within the second trough.

Cable splitter, U.S. Pat. No. 4,265,016 (priority May 24, 1978), provides a hand tool for slitting the sheath on flat, two to four conductor, plastic clad cables wherein one or more pointed knives project from the end of a handle into a chamber bounded, opposite the knife blades, by a sloping wall, one end of which defines an opening only slightly larger than the cable to be cut while the other end of the wall defines one end of an elongated opening throughout which the cable can be moved to assume a range of angles relative to the knives. A cable to be cut may be introduced into the chamber at an angle such that its surface does not touch the knives, and the tool can then be moved to an angle such that the knife points are driven into the cable and the sheath is cut, to facilitate separation and stripping of the conductors.

Cable splitter, U.S. Pat. No. 4,459,745 (priority Jun. 9, 1981), provides an having a trough disposed along the entire longitudinal length thereof. A handle extends perpendicularly from one end of the elongated member. A cutting element is positioned through a boss extending from the opposite end of the elongated member such that the cutting edge of the cutting element extends into the trough. The amount by which the cutting edge extends into the trough is made adjustable by means of set screws threadably disposed through the boss to engage the cutting element. The trough comprises a cross-sectional configuration substantially identical to the cross-sectional configuration of the cable to be slit. Thus enabling the cable splitter of this invention to slit the sheath of the cable along the edge thereof, rather than along the flat, midportion of the cable. In an alternative embodiment, a first elongated member has a first trough located along the longitudinal length thereof. A second elongated member has a second trough located along the longitudinal length thereof and a beading strip removably cooperating with the first trough for removably securing the elongated members together. A transverse channel extends through the first and second elongated members and the beading strip to guide an adjustably located cutting element such that the cutting edge of the cutting element is disposed within the second trough.

Some of the prior art inventions present certain disadvantages. The present invention has been developed for the purpose of addressing and resolving these disadvantages, by enabling the longitudinal splitting of electric cable assisted by an electric motor. A powered cable splitter, which provides a channel and clamp to secure the cable, and a circular blade set to cut to a limited depth to split the cable, would resolve this problem.

### SUMMARY OF THE INVENTION

Accordingly, the invention is directed to a powered cable splitter. The splitter is comprised of a motor, a blade, a channel, a clamp to secure the tubing within the channel, and a hand grip for activating the motor. To use the splitter, a user places the cable inside of the channel, secures it with the clamp, and then squeezes the hand grip to activate the motor. The motor causes the blade to spin and cut to a specific depth. Rollers within the channel allow the cable to be moved into position before the tubing is cut, creating a cut of limited depth along a preferred length, and thus splitting the cable without damaging the wires within.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a top view of the first exemplary embodiment, displaying the splitter 10, and the clamp 12.

FIG. 2 is a side view of the first exemplary embodiment, displaying the splitter 10, the clamp 12, the channel 13, the hand grip 14, and the housing 16.

FIG. 3 is a side perspective exploded view of the first exemplary embodiment, displaying the splitter 10, the motor 11, the clamp 12, the blade 15, the housing 16, and the bolts 17.

FIG. 4 is a side view of the first exemplary embodiment, displaying the splitter 10, the clamp 12, and the hand grip 14.

FIG. 5 is a side perspective view of the first exemplary embodiment in a partially opened condition, displaying the splitter 10, the clamp 12, the channel 13, the hand grip 14, and the blade 15.

FIG. 6 is a front perspective view of the first exemplary embodiment, displaying the splitter 10, the clamp 12, the channel 13, and the hand grip spring assembly 14A.

FIG. 7 is a side perspective view of the first exemplary embodiment, displaying the splitter 10, the clamp 12, the channel 13, and the hand grip 14.

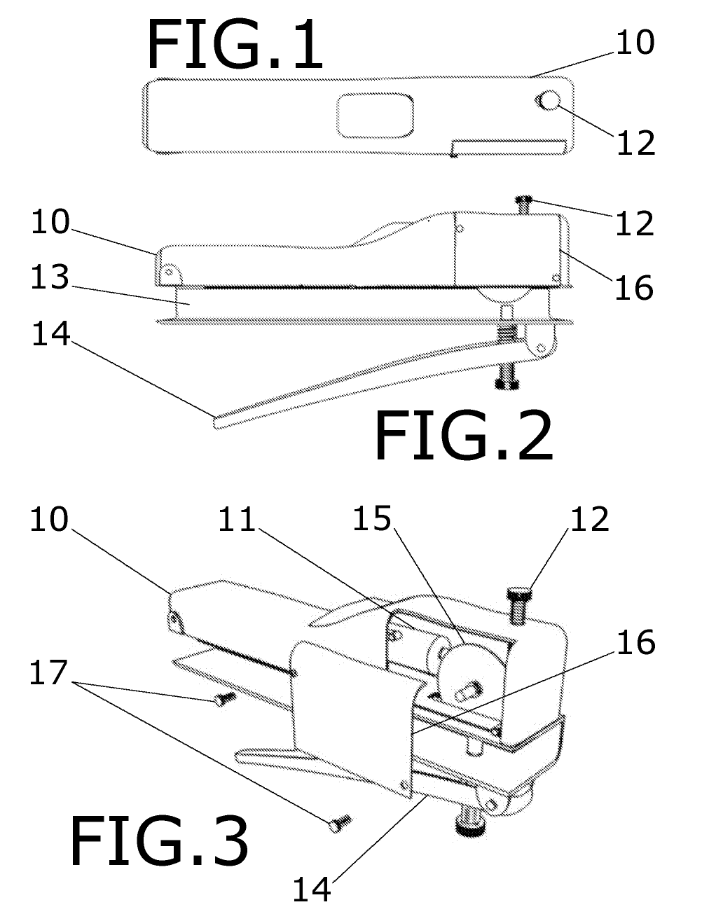

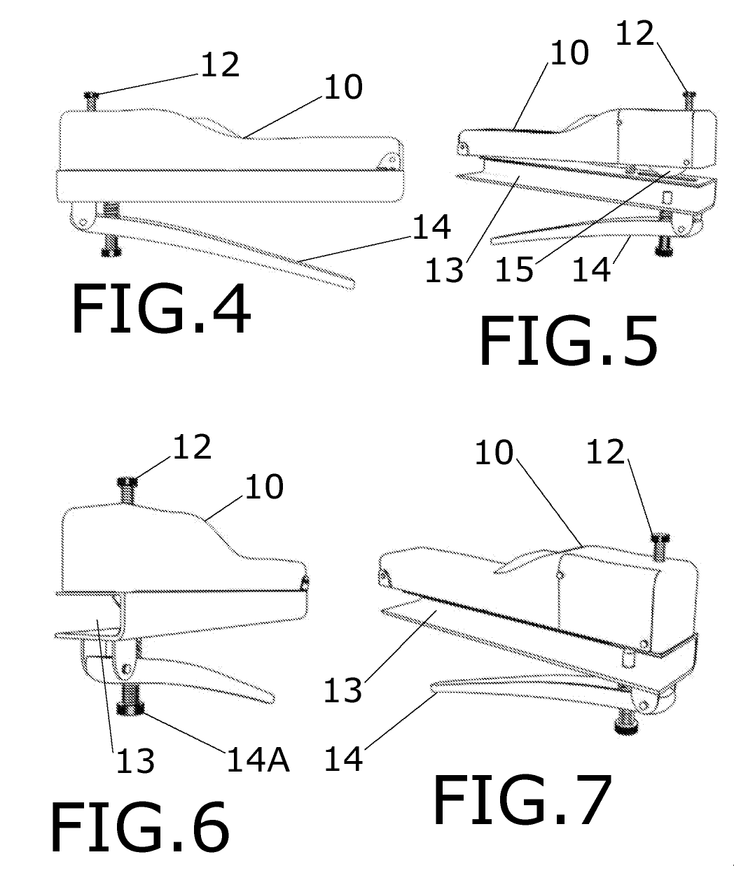

### DETAILED DESCRIPTION OF THE INVENTION

Referring now to the invention in more detail, the invention is directed to a powered cable splitter.

The first exemplary embodiment is comprised of a powered splitter 10 which is comprised of a motor 11, a circular blade 15 which is housed internally, a channel 13 which extends for most of the length of the splitter 10, a clamp 12 to secure the cable within the channel 13, a hand grip 14 for activating the motor 11, and a housing 16 to cover the motor 11 and the blade 15. The housing 16 is secured with a plurality of bolts 17 or similar fasteners. The splitter 10 may be secured to the edge of a table, workbench or counter, using mounting clamps or other fasteners which are provided.

Preferably, suitable storage space is provided within the housing 16 of the splitter 10, such that one or more spare blades 15 may be stored within the splitter 10. The blade 15 may be easily and quickly changed by the user at the job site without special tools.

An optional, removable lithium-ion battery pack may be provided at the lower end of the splitter 10. The lithium-ion battery pack may be 10 or 12 volts. The battery pack may be recharged using a recharging device which is provided. The recharging device provides a power cord, which may be plugged into any standard three-pronged wall outlet.

To use the first exemplary embodiment, the user places the cable inside of the channel 13, secures it with the clamp 12, and then squeezes the hand grip 14 to activate the motor 11. The motor 11 causes the blade 15 to spin and cut to a specific depth, which may be securely adjusted by the user. Rollers within the channel allow the cable to be moved into position before the tubing is cut, creating a cut of limited depth along a preferred length, and thus splitting the cable without damaging the wires within.

The splitter 10, the motor 11, the clamp 12, the hand grip 14, the housing 16, the bolts 17, the battery pack, and the recharging device are preferably manufactured from rigid, durable materials such as steel, brass, plastic, copper alloy, and aluminum alloy. The blade 15 and the rollers are preferably manufactured from a rigid, durable material with substantial structural strength, such as steel. The power cord is preferably manufactured from braided copper alloy wire sheathed in plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A powered cable splitter which is comprised of a motor, a circular blade which is housed internally, a channel which extends for most of the length of the splitter, a clamp to secure the cable within the channel, a hand grip for activating the motor, and a housing to cover the motor 11 and the blade.

2. The cable splitter of claim 1, wherein the housing is secured with a plurality of bolts or similar fasteners.

3. The cable splitter of claim 1, wherein the splitter may be secured to the edge of a table, workbench or counter, using mounting clamps or other fasteners which are provided.

4. The cable splitter of claim 1, wherein suitable storage space is provided within the housing of the splitter, such that one or more spare blades may be stored within the splitter.

5. The cable splitter of claim 1, wherein the blade may be easily and quickly changed by the user at the job site without special tools.

6. The cable splitter of claim 1, wherein an optional, removable 10-volt or 12-volt lithium-ion battery pack may be provided at the lower end of the splitter.

7. The cable splitter of claim 1, wherein the battery pack may be recharged using a recharging device which provides a power cord, which may be plugged into any standard three-pronged wall outlet.

8. The cable splitter of claim 1, wherein the user places the cable inside of the channel, secures it with the clamp, and then squeezes the hand grip to activate the motor.

9. The cable splitter of claim 1, wherein the motor causes the blade to spin and cut to a specific depth, which may be securely adjusted by the user.

10. The cable splitter of claim 1, wherein powered rollers within the channel cause the cable to move as the insulation is being cut, creating a cut of limited depth along a preferred length, thus removing the insulation without damaging the wires within.

11. The cable splitter of claim 1, wherein the splitter, the motor, the clamp, the hand grip, the housing, the bolts, the battery pack, and the recharging device are preferably manufactured from rigid, durable materials such as steel, brass, plastic, copper alloy, and aluminum alloy.

12. The cable splitter of claim 1, wherein the blade and the rollers are preferably manufactured from a rigid, durable material with substantial structural strength, such as steel.
